(19) United States
(12) Patent Application Publication
(10) Pub. No.: US 2026/0254485 A1
(43) Pub. Date: Aug. 27, 2026

(54) AUTOMATIC ALIGNMENT AND TRACKING METHOD

(71) Applicant: Panduit Corp., Tinley Park, IL (US)

(72) Inventors: Yu Huang, Orland Park, IL (US); Jose M. Castro, Naperville, IL (US); Thomas M. Kovanic, St. John, IN (US); Bulent Kose, Burr Ridge, IL (US)

(73) Assignee: Panduit Corp., Tinley Park, IL (US)

(21) Appl. No.: 19/063,990

(22) Filed: Feb. 26, 2025

(51) Int. Cl. H04B 7/0417; G06T 7/73

(52) U.S. Cl. CPC H04B 7/0417; G06T 7/74; G06T 2207/10024

(57) ABSTRACT

A wireless communication system with an automatic alignment function has at least one transmitter and receiver designed to facilitate the transmission of a wireless communication. The system has at least one LED placed adjacent to the at least one receiver, a laser attached to the transmitter, and a reflective surface placed near the at least one receiver. The system also has a camera deployed with the at least one transmitter wherein the camera is positioned to monitor an impact from a beam from the laser on the reflective surface. The camera further records a spot from the impact of the beam and a spotlight source from the LEDs and wherein the camera computes a disparity from the laser beam spot and the receiver via the spotlight source of the LED.

### FIELD OF INVENTION

The present invention pertains to the field of wireless communication technologies, specifically addressing high-frequency wireless communication systems. More precisely, it concerns an automatic alignment and tracking method designed to optimize the alignment and maintain the connection between a wireless transmitter and a wireless receiver operating at high-frequency bands. The invention is particularly relevant to scenarios where high-frequency wireless signals exhibit minimal divergence, rendering them susceptible to misalignment during transmission.

### BACKGROUND

As 5G networks operate within millimeter-wave (mmWave) frequencies, including those up to 39 GHz, there is a growing attraction towards utilizing even higher frequencies, such as the 60 GHz mmWave spectrum. These elevated frequencies offer several advantages, including reduced congestion compared to their lower counterparts and the capability to provide significantly higher bandwidth for wireless communication.

A critical characteristic of 60 GHz and other high-frequency signals is their remarkably narrow antenna beam divergence, typically measuring less than 5°, attributable to the higher frequency. This is shown in FIG. 1, where a transmitter 001 sends a narrow beam of 60 GHz wireless signal 002 to a receiver 003. This feature holds great significance as it allows for deploying multiple links within the same area, each pointing in slightly different directions. This phenomenon is commonly referred to as spatial discrimination or spatial division multiplexing. Notably, self-interference and other wireless disruptions are nearly non-existent at 60 GHz or higher frequency. However, this narrow beam divergence presents a challenge in aligning communication systems, as even a tiny angular misalignment can result in a complete loss of the wireless signal. Therefore, there is a need to align and keep tracking the high-frequency wireless communication system automatically.

### SUMMARY

A wireless communication system with an automatic alignment function has at least one transmitter and receiver designed to facilitate the transmission of a wireless communication. The system has at least one LED placed adjacent to the at least one receiver, a laser attached to the transmitter, and a reflective surface placed near the at least one receiver. The system also has a camera deployed with the at least one transmitter wherein the camera is positioned to monitor an impact from a beam from the laser on the reflective surface. The camera further records a spot from the impact of the beam and a spotlight source from the LEDs and wherein the camera computes a disparity from the laser beam spot and the receiver via the spotlight source of the LED.

### BRIEF DESCRIPTION OF THE DRAWINGS

FIG. 1 shows a transmitter sending a narrow beam of 60 GHz wireless signal to a transmitter.

FIG. 2 shows a camera attached to the transmitter of FIG. 1 and LEDs surrounding the receiver.

FIG. 3 shows a captured image showing the perspective of the camera sensor of FIG. 2.

FIG. 4 shows the system of FIG. 2 when it is misaligned.

FIG. 5 portrays the perspective captured by the camera sensor within FIG. 4.

FIG. 6A shows an image solely reflecting a laser beam spot due to misalignment.

FIG. 6B marks the laser beam spot with an “x”.

FIG. 6C shows an image with the laser deactivated and the LEDs surrounding the transmitter activated.

FIG. 6D shows the center of FIG. 6C marked with a “+”.

FIG. 6E shows an image with the laser and LEDs activated.

FIG. 6F shows the discrepancy between “x” and “+”.

FIG. 7 shows an instance where the misalignment is large enough to prevent the laser from being reflected on the highly reflective film.

FIG. 8A shows an image capturing the LEDs.

FIG. 8B shows the deviation between the center of the picture and the center of the LEDs.

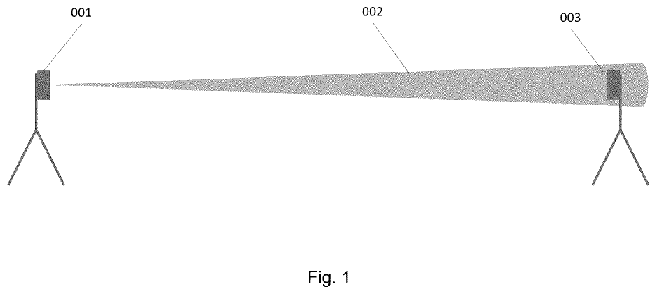

### DESCRIPTION OF INVENTION

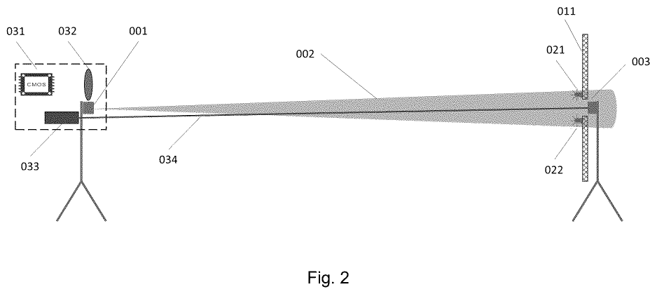

The essential factors contributing to achieving automatic alignment of a high-frequency wireless communication system revolve around two core aspects: the system's ability to detect if there is misalignment and its capacity to quantify the extent of misalignment present in the system. The extent of misalignment is defined by the displacement between the center of the wireless beam spot and the center of the receiver. As shown in FIG. 2, to achieve this, a camera consisting of a lens 032 and an image sensor 031 is attached to the transmitter 001 to determine the location of receiver 003 and its central point through the presence of LEDs 021 and 022 surrounding the receiver 003. This same camera can perceive the optical beam's spot sent by a laser 033 attached to the transmitter, where the laser beam 034 is always pointed to a fixed position of the wireless beam 002, such as the center spot of the wireless beam 002.

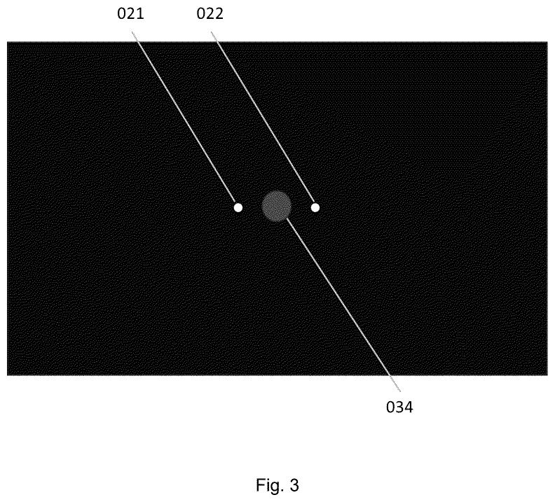

Within FIG. 2, the system achieves precise alignment, ensuring that the laser beam 034 from the transmitter 001 is accurately incident upon the center of the receiver 003. Moving to FIG. 3, a captured image reflects the perspective of the camera sensor 031 as observed in FIG. 2. This image further showcases the laser beam originating from transmitter 001, impeccably incident upon the central point of LEDs 021 and 022 on the receiver side. For convenience, the laser and the camera are installed here so the laser beam spot is at the center of the camera field of view.

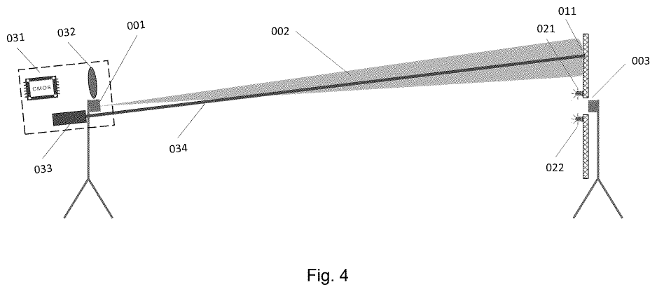

When misalignment occurs, this laser beam 034 is projected onto a highly reflective screen 011, enveloping the receiver, thus reflecting the optical beam back to the camera. FIG. 4 portrays the identical automatic alignment system, albeit with a notable distinction. Here, the laser beam stemming from transmitter 001 no longer aligns with the center of receiver 003; instead, it is incident upon the highly reflective screen 011.

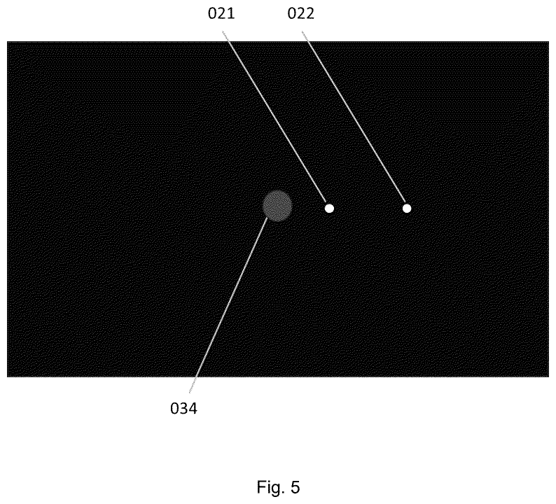

FIG. 5 portrays the perspective captured by the camera sensor 031 within FIG. 4. This imagery also encompasses the laser beam 034 originating from transmitter 001, cast upon the highly reflective film 011 at the receiver end. A comparative analysis between FIG. 3 and FIG. 5 reveals a constant alignment of the reflected laser spot on the camera sensor (positioned around the image's center), mirroring the laser beam in tandem overlap with the center of the camera image.

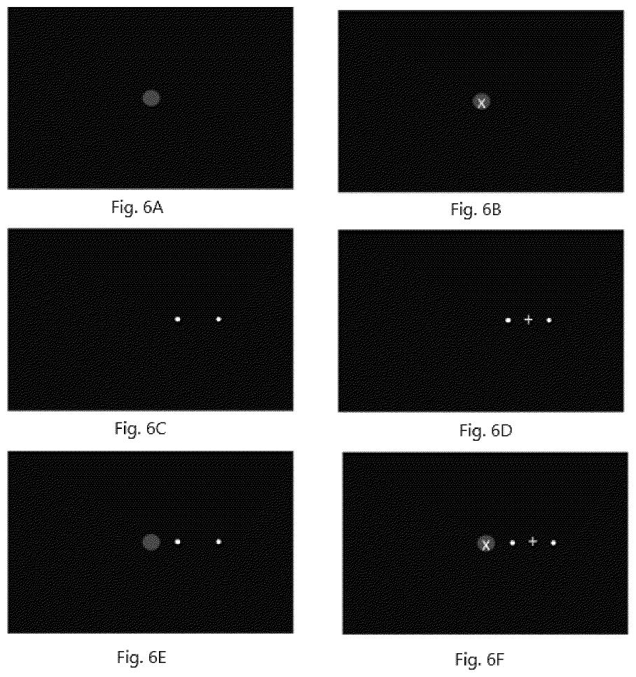

Derived from FIG. 5, it becomes evident that the laser beam suffers from misalignment, as well as the wireless beam. Additionally, we can deduce the extent of this misalignment, as shown in FIGS. 6A-F. When misalignment occurs, exemplified in FIG. 4, LEDs 021 and 022 are extinguished, and a picture is captured using camera sensor 031, resulting in FIG. 6A—an image solely featuring a reflected laser beam spot. By computing the centroid of FIG. 6A and marking its position as “x” within the same image, as indicated in FIG. 6B, we pinpoint the laser beam's location. For instance, if camera sensor 031 boasts a resolution of 1280×720, the coordinates of “x” approximate [640, 360], denoting the image's center where the laser beam spot resides.

With the laser beam's spot located, we proceed to identify the center of receiver 003—coinciding with the center of LEDs 021 and 022. At this juncture, we extinguish the laser from the transmitter side, activate LEDs 021 and 022, and capture an image using camera sensor 031, resulting in FIG. 6C. Calculating the centroid of FIG. 6C and denoting its position as “+,” visible in FIG. 6D, establishes the center of LEDs 021 and 022, synonymous with the center of receiver 003. The pixel discrepancy between “x” and “+” reveals the deviation between the laser beam spot and receiver 003, presented in FIG. 6F. Through calibration, the system determines the angular value dθ represented by each pixel. This knowledge enables the translation of the pixel difference between “x” and “+” into the angular deviation between the laser beam spot and receiver 003. Ultimately, the system regulates the angular alignment mount, realigning the laser beam with the center of receiver 003, thus concluding the automatic alignment process of the wireless system. Subsequently, camera 031 should capture an image akin to FIG. 3.

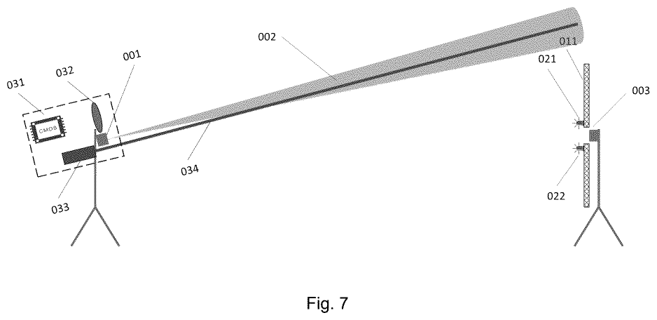

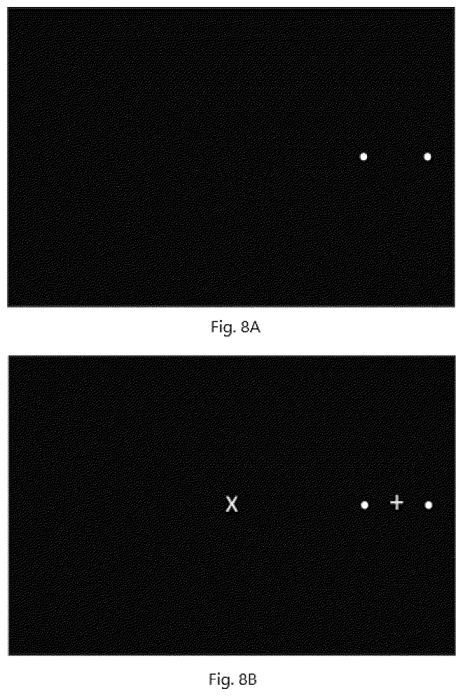

In scenarios where the initial deviation of the laser beam is extensive enough to preclude incidence on the highly reflective film 011, as shown in FIG. 7 and FIG. 8A, it remains discernible that the laser beam spot should still align roughly with the picture's center, although it is not visible in this picture as it doesn't incident on the highly reflective screen 011. This knowledge enables us to estimate the deviation between the laser beam 034 and the receiver 003, as shown in FIG. 8B. Consequently, to accommodate greater deviations between the laser beam 034 and the receiver 003, we would only need to employ a larger image sensor to create a larger field of view.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A wireless communication system with an automatic alignment function comprising:
at least one transmitter and at least one receiver designed to facilitate the transmission of a wireless communication;
at least one LED placed adjacent to the at least one receiver;
a laser attached to the at least one transmitter
at least one reflective surface placed near the at least one receiver; and
a camera deployed with the at least one transmitter wherein the camera is positioned to monitor an impact from a beam from the laser on the reflective surface and wherein the camera further records a spot from the impact of the beam and a spotlight source from the LEDs and wherein the camera computes a disparity from the laser beam spot and the receiver via the spotlight source of the LEDs.

2. The wireless communication system with an automatic alignment function of claim 1, further comprising a second transmitter placed next to the receiver and a second receiver placed adjacent to the at least one transmitter wherein the at least one transmitter, at least one, receiver, second transmitter and second receiver are configured to enable bidirectional communication.

3. The wireless communication system with an automatic alignment function of claim 1, wherein the at least one transmitter comprises a plurality of transmitters and the at least one receiver comprises a plurality of receivers and further wherein the LEDs blink at different frequencies or temporal patterns so that the camera on the transmitters can differentiate these receivers from each other.
